(19) United States
(12) Patent Application Publication
(10) Pub. No.: US 2011/0292298 A1
(43) Pub. Date: Dec. 1, 2011

(54) INPUT TUNING CIRCUIT OF TELEVISION TUNER

(75) Inventor: Akira HASHIMOTO, Miyagi-Ken (JP)

(73) Assignee: ALPS ELECTRIC CO., LTD., Tokyo (JP)

(21) Appl. No.: 13/096,763

(22) Filed: Apr. 28, 2011

(30) Foreign Application Priority Data
May 25, 2010 (JP) 2010-119254

(51) Int. Cl. H04N 5/50

(52) U.S. Cl. 348/731; 348/E05.097

(57) ABSTRACT

In an input tuning circuit, during reception of a television signal in the UHF band, a second tuning circuit unit is tuned to the UHF band by turning on a first switching diode, and a first tuning circuit unit is made to operate as a trap circuit in a frequency range lower than the UHF band by turning on a second switching diode. As a result, the transmission characteristics of the second tuning circuit unit become narrow and interference characteristics are improved. In addition, since a dedicated trap circuit need not be separately provided, an increase in cost is limited to a minimum and an increase in size is prevented.

### CLAIM OF PRIORITY

This application claims benefit of Japanese Patent Application No. 2010-119254 filed on May 25, 2010, which is hereby incorporated by reference.

### BACKGROUND OF THE INVENTION

1. Field of the Invention

The present invention relates to input tuning circuits that can be used in input stages of television tuners.

2. Description of the Related Art

Existing related art input tuning circuits of television tuners include a band-switching input tuning circuit configured to be tuned to each of the VHF-Low band, VHF-High band, and UHF band (refer to Japanese Registered Utility Model No. 3101830, for example). This band-switching input tuning circuit includes a first tuning circuit unit for tuning to television signals in the VHF-Low/High bands and a second tuning circuit unit for tuning to television signals in the UHF band, and the first and second tuning circuit units are switched using switching means such as a switching diode.

### SUMMARY OF THE INVENTION

In the related art input tuning circuits, there has been a requirement for improved interference characteristics during UHF band reception. Although the interference characteristics can be improved by adding a trap circuit to the second tuning circuit unit, which is on the UHF receiver side, adding a trap circuit may result in increases in the size and cost of the circuit.

In view of this, the present invention provides an input tuning circuit that can improve the interference characteristics during UHF band reception while suppressing an increase in cost and realizing a reduction in size.

An input tuning circuit of a television tuner of the present invention includes: a first tuning circuit unit, connected to an input end, capable of selectively receiving signals in a first frequency band and a second frequency band having higher frequencies than the first frequency band; a second tuning circuit unit, connected to the input end in parallel with the first tuning circuit unit, capable of receiving a signal in a third frequency band having higher frequencies than the second frequency band; a first switching device provided between the input end and the second tuning circuit unit. The first tuning circuit unit includes: a plurality of tuning inductors; a variable capacitance device forming, together with the plurality of the tuning inductors, a tuning circuit; and a second switching device that is turned off during reception in the first frequency band and that is turned on during reception in the second frequency band, thereby lowering an inductance value within the tuning circuit. During reception in the third frequency band, the first switching device is turned on, and the second switching device is turned on, thereby forming a trap in a frequency range lower than frequencies of reception signals in the third frequency band.

According to this configuration, during reception in the third frequency band, the first switching device is turned on, thereby making the second tuning circuit unit be tuned to the third frequency band, and the second switching device is turned on, thereby forming a trap in a frequency range lower than the frequencies of reception signals in the third frequency band, in the first tuning circuit unit connected to the second tuning circuit unit. Hence, the Q factor of the second tuning circuit unit is improved, whereby the interference characteristics are improved. In addition, since an existing VHF tuning circuit unit is utilized as a trap circuit to form a trap during reception in the third frequency band, there is no increase in the number of components, an increase in cost can be limited to a minimum, and an increase in the size of the circuit can be prevented.

According to the present invention, in the input tuning circuit of a television tuner circuit, the first tuning circuit unit is preferably formed of: a first inductor one end of which is connected to the input end; a second inductor one end of which is connected to the input end; a third inductor connected between the other end of the first inductor and the ground; the variable capacitance device connected between the other end of the second inductor and the ground; the second switching device connected between the other end of the first inductor and the other end of the second inductor; and a fourth inductor either connected between the other end of the first inductor and the other end of the second inductor in series with the second switching device or inserted between the other end of the second inductor and the variable capacitance device.

According to this configuration, during reception in the third frequency band, the first tuning circuit unit is connected to the second tuning circuit unit by turning on the first switching device, and the fourth inductor is inserted by turning off the second switching device, whereby the inductance value of the first tuning circuit unit can be lowered and a trap can be formed in a frequency range lower than the reception signal frequency of the third frequency band.

According to the present invention, in the input tuning circuit of a television tuner circuit, it is preferable that a capacitor connectable in parallel with the variable capacitance device be provided, the capacitor be connected during reception in the first and second frequency bands, and the capacitor be not connected during reception in the third frequency band.

According to this configuration, it is preferable that a capacitor be connected in parallel with the variable capacitance device during reception in the first and second frequency bands, and the capacitor be disconnected during reception in the third frequency band so as to lower the capacitance. By making the capacitance of the first tuning circuit unit lower during reception in the third frequency band, the first tuning circuit unit can be made to operate as a trap circuit in a frequency range lower than the reception frequency of the third frequency band, whereby the Q factor of the second tuning circuit unit can be improved and the interference characteristics can be further improved.

According to the present invention, in the input tuning circuit of a television tuner circuit, it is preferable that a capacitor connectable in series with the variable capacitance device be provided, the capacitor be not connected during reception in the first and second frequency bands, and the capacitor be connected during reception in the third frequency band.

According to this configuration, by connecting a capacitor in series with the variable capacitance device, the combined capacitance of the capacitor and the variable capacitance device becomes smaller than the capacitance at the time when the capacitor is not connected. Hence, during reception in the third frequency band, by performing control such that the combined capacitance becomes smaller than the capacitance at the time when signals in the first and second frequency bands are received, a trap can be formed by the first tuning circuit unit in a frequency range lower than the reception signal frequency of the third frequency band.

According to the present invention, in the input tuning circuit of a television tuner circuit, the first frequency band may be a low band of a VHF band, the second frequency band may be a high band of the VHF band, and the third frequency band may be a UHF band.

According to the present invention, in a band-switching input tuning circuit, the interference characteristics can be improved during reception in the UHF band while suppressing an increase in cost and reducing the size of the circuit.

### BRIEF DESCRIPTION OF THE DRAWINGS

FIG. 1 illustrates a circuit configuration of an input tuning circuit according to a first embodiment of the present invention; and

FIG. 2 illustrates the on/off states of switching diodes during reception of television signals in the VHF-Low/High bands and UHF band in the input tuning circuit illustrated in FIG. 1;

FIG. 3 illustrates a schematic configuration of the input tuning circuit illustrated in FIG. 1 at the time when a VHF band tuning circuit unit is used as a trap circuit;

FIG. 4 illustrates an equivalent circuit of the VHF band tuning circuit unit illustrated in FIG. 3;

FIG. 5 illustrates the transmission characteristics of the UHF band tuning circuit unit in the input tuning circuit illustrated in FIG. 1;

FIG. 6 illustrates a schematic configuration of an input tuning circuit according to a second embodiment of the present invention at the time when a VHF band tuning circuit unit is used as a trap circuit;

FIG. 7 illustrates the transmission characteristics of a UHF band tuning circuit unit in the input tuning circuit illustrated in FIG. 6; and

FIG. 8 illustrates a schematic configuration of an input tuning circuit according to a third embodiment of the present invention at the time when a VHF band tuning circuit unit is used as a trap circuit;

### DESCRIPTION OF THE PREFERRED EMBODIMENTS

Hereinafter, embodiments of the present invention are described in detail with reference to the attached drawings.

### First Embodiment

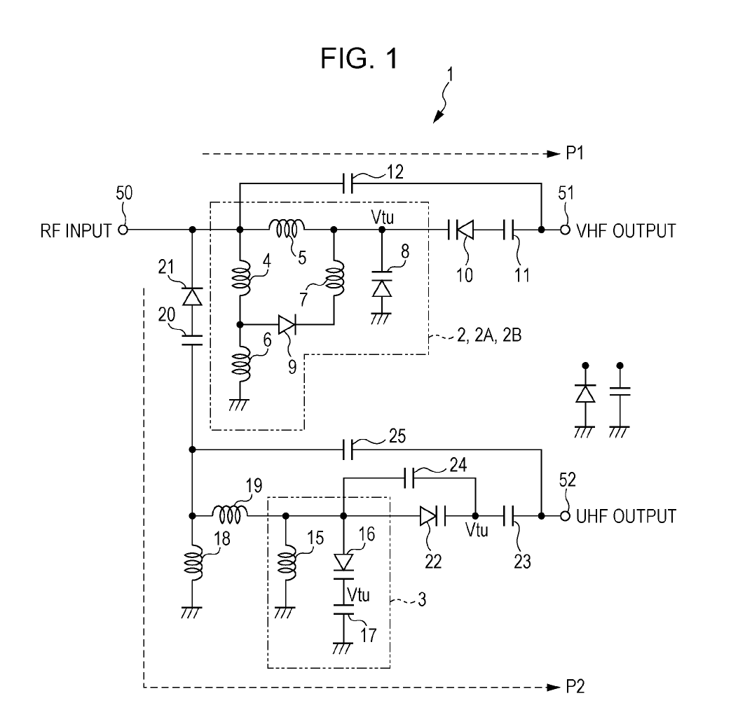

FIG. 1 illustrates a circuit configuration of an input tuning circuit according to a first embodiment of the present invention. In FIG. 1, an input tuning circuit 1 of the present embodiment is a band-switching tuning circuit which can be tuned to each of the VHF-Low band, VHF-High band, and UHF band, and includes a VHF tuning circuit unit 2 tuned to the signals in the VHF-Low/High bands and a UHF tuning circuit unit 3 tuned to signals in the UHF band.

The VHF tuning circuit unit 2 preferably includes tuning inductors 4 and 5 (first and second inductors), first ends of which are both connected to an RF input terminal 50, a tuning inductor (third inductor) 6 connected between the second end of the tuning inductor 4 and the ground, a tuning inductor (fourth inductor) 7, one end of which is connected to the second end of the tuning inductor 5, a tuning varactor diode (variable capacitance device) 8, whose cathode is connected to the second end of the tuning inductor 5 and whose anode is connected to the ground, and a switching diode (second switching device) 9, whose anode is connected to the second end of the tuning inductor 4 and whose cathode is connected to the other end of the tuning inductor 7. The VHF tuning circuit unit 2 becomes a VHF tuning circuit unit 2A with the other end of the tuning inductor 7 being open during reception of a television signal in the VHF-Low band, and becomes a VHF tuning circuit unit 2B with the tuning inductor 7 being inserted during reception of a television signal in the VHF-High band.

A tuning voltage Vtu is applied to the cathode of the tuning varactor diode 8 of the VHF tuning circuit unit 2. The tuning voltage Vtu in accordance with the frequency of a channel during station selection within the VHF-Low/High bands is applied to the tuning varactor diode 8. A television signal in the VHF-Low/High bands to which the VHF tuning circuit unit 2 is tuned is output from a VHF output terminal 51 through a varactor diode 10 and a DC cut capacitor 11. A capacitor 12 having supplemental capacitance (capacitance for supplementing another capacitance when the voltage applied to the tuning varactor diode 8 is high) is inserted between the VHF output terminal 51 and the RF input terminal 50.

The UHF tuning circuit unit (second tuning circuit) 3 includes a tuning inductor 15, one end of which is connected to the signal line side and the other end of which is connected to the ground, a tuning varactor diode (variable capacitance device) 16, whose anode is connected to the one end of the tuning inductor 15 and whose cathode is connected to the ground through a DC cut capacitor 17. The UHF tuning circuit unit 3 is connected to the RF input terminal 50 through impedance adjustment inductors 18 and 19, a DC cut capacitor 20, and a switching diode (first switching device) 21. The switching diode 21 is inserted with the cathode thereof directed toward the RF input terminal 50.

The tuning voltage Vtu is applied to the cathode of the tuning varactor diode 16 of the UHF tuning circuit unit 3 and the cathode of a tuning varactor diode 22. The tuning voltage Vtu in accordance with the frequency of a channel during station selection within the UHF band is applied to the tuning varactor diodes 16 and 22. A television signal in the UHF band to which the UHF tuning circuit unit 3 is tuned is output from a UHF output terminal 52 through the tuning varactor diode 22 and a DC cut capacitor 23. Note that a capacitor 24 is connected in parallel across the two terminals of the tuning varactor diode 22. A capacitor 25 having supplemental capacitance (capacitance for supplementing another capacitance when the voltage applied to the tuning varactor diodes 16 and 22 is high) is inserted in parallel between the UHF output terminal 52 and the input side of the impedance adjustment inductors 18 and 19.

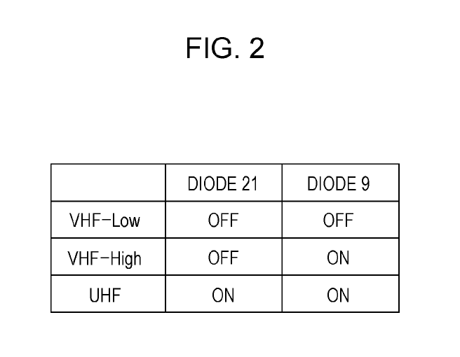

FIG. 2 illustrates the on/off states of the switching diodes 21 and 9 at the time when television signals in the VHF-Low/High bands and the UHF band are received. When a television signal in the VHF-Low band is to be received, both the switching diodes 21 and 9 are turned off. Thereby, a signal path P2 is cut and the UHF tuning circuit unit 3 side becomes open on the UHF reception side. On the other hand, on the VHF reception side, the other end of the tuning inductor 7 becomes open, and the VHF tuning circuit unit 2A in which the tuning band is made to match the VHF-Low band is formed, whereby a television signal in the VHF-Low band can be received.

When a television signal in the VHF-High band is to be received, switching diodes 21 is turned off and the switching diode 9 is turned on, as illustrated in FIG. 2. By turning off the switching diode 21, similarly to as in the reception of a television signal in the VHF-Low band, a signal path P2 is cut on the UHF reception side. On the other hand, on the VHF reception side, the tuning inductor 7 is inserted by turning on the switching diode 9, and the VHF tuning circuit unit 2B in which the tuning band is made to match the VHF-High band is formed, whereby a television signal in the VHF-High band can be received.

When a television signal in the UHF band is to be received, both the switching diodes 21 and 9 are turned on, as illustrated in FIG. 2. As a result of the switching diode 21 being turned on, a television signal in the UHF band propagates through the signal path P2 through the DC cut capacitor 20, whereby the television signal in the UHF band can be received by the UHF tuning circuit unit 3 formed of the tuning inductor 15 and the tuning varactor diode 16.

On the other hand, as a result of the switching diode 9 of the VHF tuning circuit unit 2 having been turned on, the VHF tuning circuit unit 2B having a configuration corresponding to the VHF-High band is connected to the RF input terminal 50 in parallel with the UHF tuning circuit unit 3. Since the tuning voltage Vtu is applied to the VHF tuning circuit unit 2B in parallel with the UHF tuning circuit unit 3, the state of the VHF tuning circuit unit 2B changes together with the UHF tuning circuit unit 3. At this time, the VHF tuning circuit unit 2B functions as a trap circuit having an attenuation pole in a frequency range lower than the frequency of a signal received in the UHF band, rather than being used to receive a television signal in the VHF-High band.

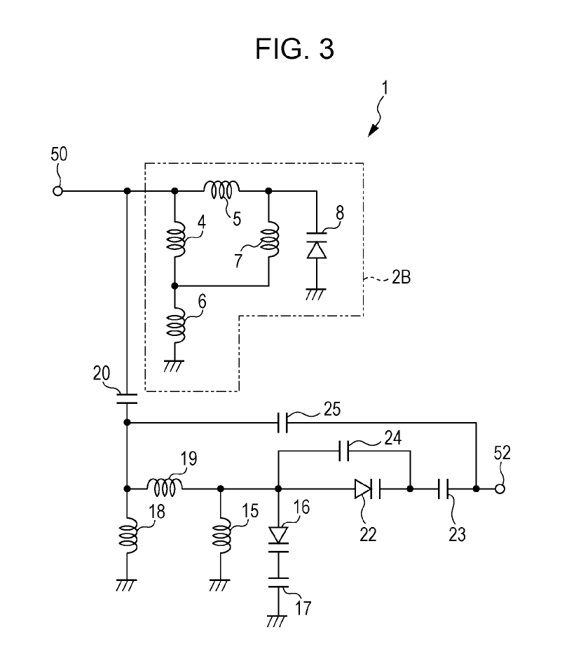

FIG. 3 illustrates a schematic configuration of the input tuning circuit 1 at the time when the VHF tuning circuit unit 2B is used as a trap circuit during reception in the UHF band. Since the switching diode 9 is turned on, the VHF tuning circuit unit 2B including the tuning inductor 7 is added to the UHF tuning circuit unit 3 as a trap circuit.

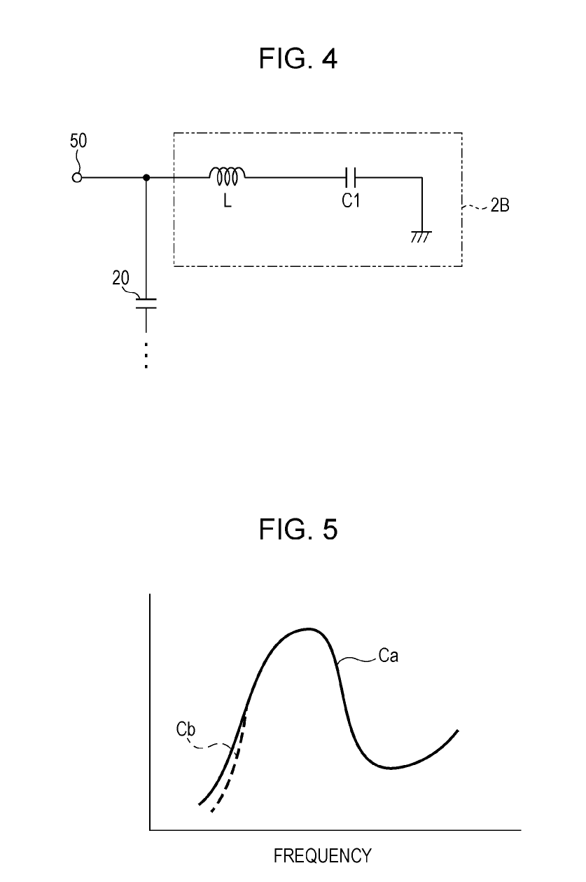

FIG. 4 illustrates an equivalent circuit of the VHF tuning circuit unit 2B when the switching diode 9 is on. The tuning inductors 5 to 7 are represented by a single inductor L. A capacitor C1 mainly represents the capacitance of the tuning varactor diode 8.

During reception in the UHF band, the transmission characteristics of the UHF tuning circuit unit 3 become narrow, that is, become steep as a result of the trap circuit illustrated in FIG. 4 being connected to the UHF tuning circuit unit 3. It can be said that the Q factor of the UHF tuning circuit unit 3 becomes high.

FIG. 5 illustrates the transmission characteristics of the UHF tuning circuit unit 3 to which the trap circuit illustrated in FIG. 4 has been attached. Characteristics Ca represented using a solid line correspond to the case in which the trap circuit realized by the VHF tuning circuit unit 2B for the VHF-High band does not exist, and characteristics Cb, particularly in a low frequency range, represented using a broken line correspond to the case in which the trap circuit realized by the VHF tuning circuit unit 2B for the VHF-High band is connected. In other words, the transmission characteristics of the UHF tuning circuit unit 3 in a low frequency range can be made to be steep by connecting the VHF tuning circuit unit 2B for the VHF-High band as a trap circuit. As a result of the transmission characteristics becoming steep in a frequency range lower than the frequencies of signals received in the UHF band, interference waves in the frequency range can be suppressed and interference characteristics in the UHF tuning circuit unit 3 for the UHF band can be improved.

As described above, in the input tuning circuit 1 of the present embodiment, by turning on the switching diode 21 and the switching diode 9 during reception in the UHF band, the VHF tuning circuit unit 2B for the VHF-High band is connected to the UHF tuning circuit unit 3 so as to operate as a trap circuit, whereby sufficient attenuation on the lower frequency side of the UHF band is realized. Hence, the Q factor of the UHF tuning circuit unit 3 can be improved (steep characteristics can be obtained), whereby interference characteristics can be improved. In addition, since the VHF tuning circuit unit 2, which already exists, is utilized as a trap circuit, there is no need to separately provide a dedicated trap circuit. Hence, an increase in cost can be limited to a minimum and there is no increase in the size of the circuit.

### Second Embodiment

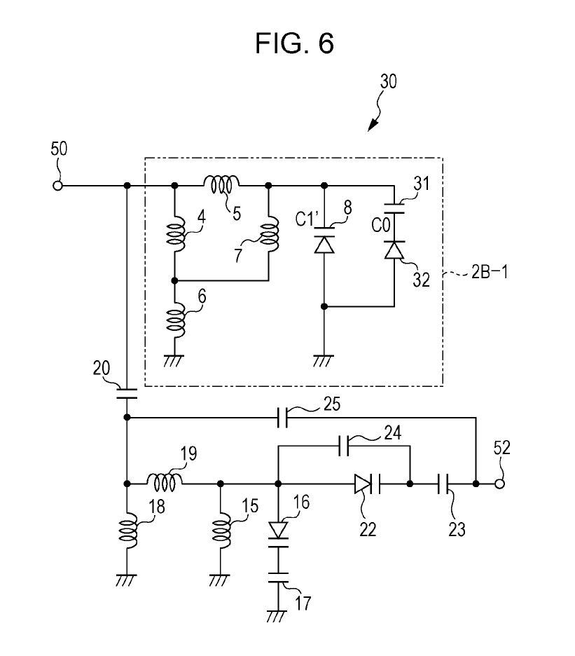

FIG. 6 illustrates a circuit configuration of an input tuning circuit according to a second embodiment of the present invention. In FIG. 6, components which are common to those in FIGS. 1 and 3 are denoted by the same symbols. In the second embodiment, a VHF tuning circuit unit 2B-1 for the VHF-High band is used as a trap circuit during reception in the UHF band.

In an input tuning circuit 30 of the present embodiment, a series circuit formed of a capacitor 31 and a switching diode 32 is preferably connected in parallel with the tuning varactor diode 8 of the VHF tuning circuit unit 2 for the VHF band. The switching diode 32 is preferably turned on during reception of a television signal in the VHF-Low/High bands, thereby inserting the capacitor 31. The switching diode 32 is preferably turned off during reception in the UHF band to eliminate the influence of the capacitor.

By making the capacitance of the tuning varactor diode 8 of the VHF tuning circuit unit 2 for the VHF band, which is used as a trap circuit, smaller than a typical value (value corresponding to the circuit configuration illustrated in FIG. 1), the Q factor of the UHF tuning circuit unit 3 for the UHF band can be further improved, when the VHF tuning circuit unit 2B-1 for the VHF-High band is utilized as a trap circuit. This allows the interference characteristics in the UHF tuning circuit unit 3 during reception in the UHF band to be further improved.

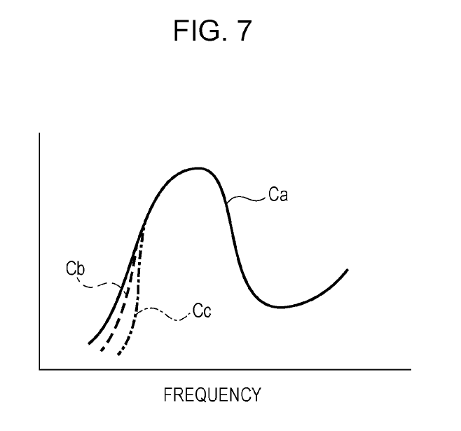

FIG. 7 illustrates the transmission characteristics of the UHF tuning circuit unit 3 during reception in the UHF band. Characteristics Ca represented using a solid line correspond to the case in which the trap circuit realized by the VHF tuning circuit unit 2B-1 for the VHF-High band does not exist, and characteristics Cc, particularly in a low frequency range, represented using a one-dot chain line correspond to the case in which the trap circuit realized by the VHF tuning circuit unit 2B-1 for the VHF-High band exists. In other words, the transmission characteristics of the UHF tuning circuit unit 3 for the UHF band become narrow by providing the VHF tuning circuit unit 2B-1 for the VHF-High band as a trap circuit. As a result of the transmission characteristics becoming steep in a frequency range lower than the frequencies of signals received in the UHF band, interference waves in the frequency range can be suppressed and interference characteristics in the UHF tuning circuit unit 3 for the UHF band can be improved.

Note that if the capacitance of the tuning varactor diode 8 of the VHF tuning circuit unit 2 is set for a trap circuit, the capacitance needs to be changed back to a typical capacitance during reception of a television signal in the VHF-Low/High bands. In that case, the capacitor 31 is connected in parallel with the tuning varactor diode 8 by turning on the switching diode 32. Hence, in this case, assuming that the capacitance of the tuning varactor diode 8 during reception of a television signal in the VHF-Low/High bands is C1, the capacitance of the tuning varactor diode 8 in the case of being used for a trap circuit is C1′, and the capacitance of the capacitor 31 connected in parallel with the tuning varactor diode 8 is C0, C1 is C1′+C0.

As described above, in the input tuning circuit 30 of the present embodiment, by allowing the capacitor 31 to be connected in parallel with the tuning varactor diode 8 of the VHF tuning circuit unit 2 for the VHF band, the capacitor 31 is inserted during reception of a television signal in the VHF-Low/High bands and the capacitor 31 is made to be nonexistent for high frequencies during reception of a television signal in the UHF band. Hence, the transmission characteristics in the UHF tuning circuit unit 3 can be made to be even narrower during reception in the UHF band, whereby the interference characteristics in the UHF tuning circuit unit 3 can be further improved.

### Third Embodiment

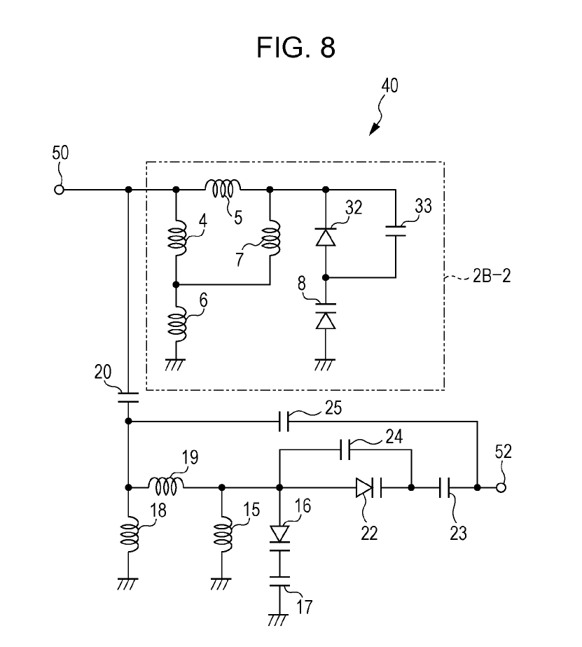

FIG. 8 illustrates a circuit configuration of an input tuning circuit according to a third embodiment of the present invention. In FIG. 8, components which are common to those illustrated in FIGS. 1, 3, and 6 are denoted by the same symbols. In the third embodiment, a VHF tuning circuit unit 2B-2 for the VHF-High band is utilized as a trap circuit during reception in the UHF band.

In an input tuning circuit 40 of the present embodiment, a parallel circuit formed of a capacitor 33 and the switching diode 32 is preferably connected in series with the tuning varactor diode 8 of the VHF tuning circuit unit 2. The switching diode 32 is preferably turned on during reception of a television signal in the VHF-Low/High bands, thereby making the capacitor 33 be in a disconnected state for high frequencies. The switching diode 32 is preferably turned off during reception in the UHF band to connect the capacitor 33. In other words, connection/disconnection of the capacitor 33 to/from the tuning varactor diode 8 is made in a reverse manner compared with the input tuning circuit 30 of the second embodiment described above.

By connecting the capacitor 33 in series with the tuning varactor diode 8, the combined capacitance of the capacitor 33 and the tuning varactor diode 8 becomes smaller than the capacitance of the tuning varactor diode 8 alone. Hence, by making the VHF tuning circuit unit 2 be the VHF tuning circuit unit 2B-2 for the VHF-High band and by utilizing the VHF tuning circuit unit 2B-2 as a trap circuit, the transmission characteristics of the UHF tuning circuit unit 3 for the UHF band can be made to be even narrower. As a result, the interference characteristics in the UHF tuning circuit unit 3 for the UHF band can be further improved also in this case.

As described above, in the input tuning circuit 40 of the present embodiment, by providing the capacitor 33, which can be connected in series with the tuning varactor diode 8 of the VHF tuning circuit unit 2 for the VHF band, the capacitor 33 is disconnected during reception of a television signal in the VHF-Low/High bands and the capacitor 33 is connected during reception of a television signal in the UHF band. Hence, the transmission characteristics in the UHF tuning circuit unit 3 can be made to be even narrower during reception in the UHF band, whereby interference characteristics in the UHF tuning circuit unit 3 can be further improved.

The present invention can be applied as an input tuning circuit of a television.

What is claimed is:

1. An input tuning circuit of a television tuner, comprising:
a first tuning circuit unit, connected to an input end, capable of selectively receiving signals in a first frequency band and a second frequency band having higher frequencies than the first frequency band;
a second tuning circuit unit, connected to the input end in parallel with the first tuning circuit unit, capable of receiving a signal in a third frequency band having higher frequencies than the second frequency band; and
a first switching device provided between the input end and the second tuning circuit unit,
wherein the first tuning circuit unit includes:
a plurality of tuning inductors;
a variable capacitance device forming, together with the plurality of the tuning inductors, a tuning circuit; and
a second switching device that is turned off during reception in the first frequency band and that is turned on during reception in the second frequency band, thereby lowering an inductance value within the tuning circuit, and
wherein, during reception in the third frequency band, the first switching device is turned on, and the second switching device is turned on, thereby forming a trap in a frequency range lower than frequencies of reception signals in the third frequency band.

2. The input tuning circuit of a television tuner circuit according to claim 1, wherein the first tuning circuit unit is formed of:
a first inductor one end of which is connected to the input end;
a second inductor one end of which is connected to the input end;
a third inductor connected between the other end of the first inductor and the ground;
the variable capacitance device connected between the other end of the second inductor and the ground;
the second switching device connected between the other end of the first inductor and the other end of the second inductor; and
a fourth inductor either connected between the other end of the first inductor and the other end of the second inductor in series with the second switching device or inserted between the other end of the second inductor and the variable capacitance device.

3. The input tuning circuit of a television tuner circuit according to claim 1,
wherein a capacitor connectable in parallel with the variable capacitance device is provided,
wherein the capacitor is connected during reception in the first and second frequency bands, and
wherein the capacitor is not connected during reception in the third frequency band.

4. The input tuning circuit of a television tuner circuit according to claim 1,
wherein a capacitor connectable in series with the variable capacitance device is provided,
wherein the capacitor is not connected during reception in the first and second frequency bands, and
wherein the capacitor is connected during reception in the third frequency band.

5. The input tuning circuit of a television tuner circuit according to claim 1,
wherein the first frequency band is a low band of a VHF band,
wherein the second frequency band is a high band of the VHF band, and
wherein the third frequency band is a UHF band.
